(19) United States
(12) Patent Application Publication
(10) Pub. No.: US 2007/0169650 A1
(43) Pub. Date: Jul. 26, 2007

(54) Housing assembly for a self-inking stamp

(76) Inventor: Shiny Shih, Yungkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,358

(22) Filed: Jan. 17, 2006

(51) Int. Cl. B41K 1/42

(52) U.S. Cl. 101/333

(57) ABSTRACT

A housing assembly for a self-inking stamp is mounted detachably on a stationary casing of the self-inking stamp and has a slidable casing and a transparent cover. The slidable casing has a top, two ends, an open bottom, an identification recess and a curved recess. The identification recess is formed on the slidable casing to hold an object for identification or decoration. The transparent cover corresponds to the identification recess, is detachably mounted in the identification recess and has a soft mat. The soft mat is soft and slip-proof so people can press the soft mat strongly to remove the transparent cover to change the object in the identification recess.

### BACKGROUND OF THE INVENTION

1. Field of the Invention

The present invention relates to a self-inking stamp, and more particularly to a housing assembly for a self-inking stamp.

2. Description of the Related Art

To save time and be convenient, a self-inking stamp was invented to imprint sequentially numbered impressions on multiple documents without having to repeatedly apply ink from an external inkpad.

With reference to FIGS. 5 and 6, a self-inking stamp in accordance with the prior art comprises a stationary casing (60), an inkpad (62), a printing pad (63), a housing assembly (70), two retaining members (82) and a spring (81).

The stationary casing (60) is hollow and has a top (not numbered), an open bottom (not numbered), two ends (not numbered), a front (not numbered), two imprinting slots (61), two detents (65) and an inkpad slot (not numbered). The imprinting slots (61) are longitudinally defined respectively in the ends of the stationary casing (60). The detents (65) are defined respectively in the ends of the stationary casing (60) above the imprinting slots (61). The inkpad slot is defined laterally in the front of the stationary casing (60) above the imprinting slots (61).

The inkpad (62) holds ink, is mounted detachably in the inkpad slot in the stationary casing (60) and has a bottom inking face (not numbered).

The printing pad (63) is slidably and rotatably mounted in the stationary casing (60) and has two ends (not numbered), two stubs (64) and a printing face (not numbered). The stubs (64) are formed respectively on and protrude from the ends of the printing pad (63) and are slidably mounted respectively in the imprinting slots (61). The printing face abuts the bottom inking face of the inkpad (62) in a default situation and is selectively depressed down along the imprinting slots (61) and rotates downward to transfer an image to a document or the like to be stamped.

The housing assembly (70) is detachably mounted on the stationary casing (60) to keep dust from getting into the stationary casing (60) and has a slidable casing (74) and a transparent cover (73).

The slidable casing (74) is mounted slidably on the stationary casing (60) and has a top (not numbered), a front (not numbered), a rear (not numbered), two ends (not numbered), an open bottom (not numbered), two retaining holes (71), two drive holes (75), a identification recess (72) and a curved recess (76). The retaining holes (71) are defined respectively in the ends of the slidable casing (74). The drive holes (75) are defined respectively inside the ends of the slidable casing (74) below the retaining holes (71) and pivotally and respectively hold the studs (64) of the printing pad (63). The identification recess (72) is formed in the top, front and rear of the slidable casing (74), can hold an object like a label (not shown), a picture (not shown) or a nametag (not shown) and has bottom edges (not numbered) and multiple bosses (721). The bottom edges are formed respectively on the front and rear of the slidable casing (74). The bosses (721) are formed respectively near the bottom edges. The curved recess (76) is defined in the front or rear of the slidable casing (74) and communicates with one of the bottom edges of the identification recess (72).

The transparent cover (73) corresponds to and is mounted detachably in the identification recess (72) and has multiple mounting detents (731). The mounting detents (731) correspond respectively to and are selectively mounted on the bosses (721) of the identification recess (72) to hold the transparent cover (73) in the identification recess (72) of the slidable casing (74). The transparent cover (73) is removed from the identification recess (72) by prying the mounting detents (731) off the bosses (721) at the curved recess (76).

The retaining members (82) are retractably mounted respectively in the retaining holes (71) in the slidable casing (74). When the self-inking stamp is not in use, the slidable casing (74) can be moved down, and the retaining members (82) can be pressed into the detents (65) to hold the printing pad (63) away from the inkpad (65).

The spring (81) is mounted in the slidable casing (74) between the top of the stationary casing (60) and the top of the slidable casing (74) and pushes the slidable casing (74) up when the slidable casing (74) is released.

However, the housing assembly (70) as described has the following shortcomings and disadvantages. The surface of the transparent cover (73) is too smooth to be pressed tightly, and the edge of the transparent cover (73) is so coarse that the edge may injure people attempting to remove the transparent cover (73).

### SUMMARY OF THE INVENTION

The primary objective of the present invention is to provide a housing assembly having a transparent cover that can be removed easily and safely.

The housing assembly in accordance with the present invention is detachably mounted on a stationary casing of a self-inking stamp and comprises a slidable casing and a transparent cover.

The slidable casing has a top, two ends, an open bottom, a bottom edge, an identification recess and a curved recess. The identification recess is formed between the two ends of the slidable casing, can hold an object like a label, a picture or a nametag and has at least one bottom edge. The at least one bottom edge is formed in the slidable casing below the top of the slidable casing. The curved recess is defined in the slidable casing and communicates with the identification recess.

The transparent cover corresponds to and is detachably mounted in the identification recess and has a surface, a bottom edge and a soft mat. The soft mat is mounted on the surface of the transparent cover and has a bottom edge corresponding to the bottom edge of the transparent cover and exposed to the curved recess.

The transparent cover can be removed to change the object in the identification recess. The soft mat is resilient and slip-proof and allows the bottom edge of the soft mat to be pressed safety with considerable force to remove the transparent cover easily.

### BRIEF DESCRIPTION OF THE DRAWINGS

FIG. 1 is an exploded perspective view of a first embodiment of a housing assembly for a self-inking stamp in accordance with the present invention;

FIG. 2 is an exploded perspective view of a second embodiment of a housing assembly for a self-inking stamp in accordance with the present invention;

FIG. 3 is a perspective view of the self-inking stamp with the housing assembly in FIG. 1;

FIG. 4 is a front view in partial section of the self-inking stamp in FIG. 3;

FIG. 5 is a perspective view of a conventional self-inking stamp in accordance with the prior art; and

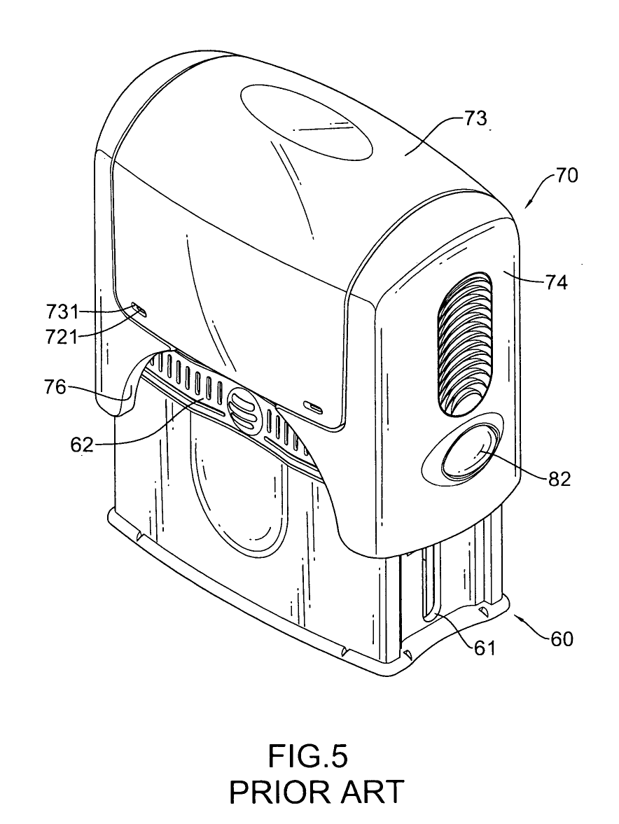

FIG. 6 is a front view in partial section of the self-inking stamp in FIG. 5.

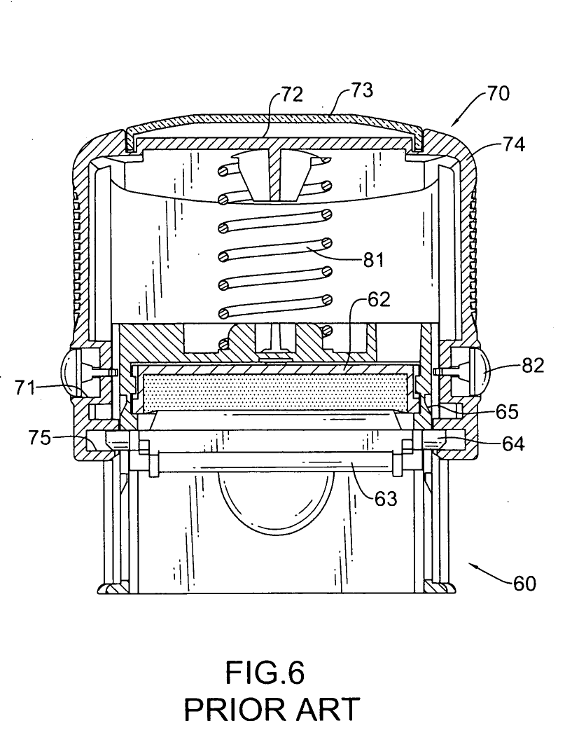

### DETAILED DESCRIPTION OF THE PREFERRED EMBODIMENT

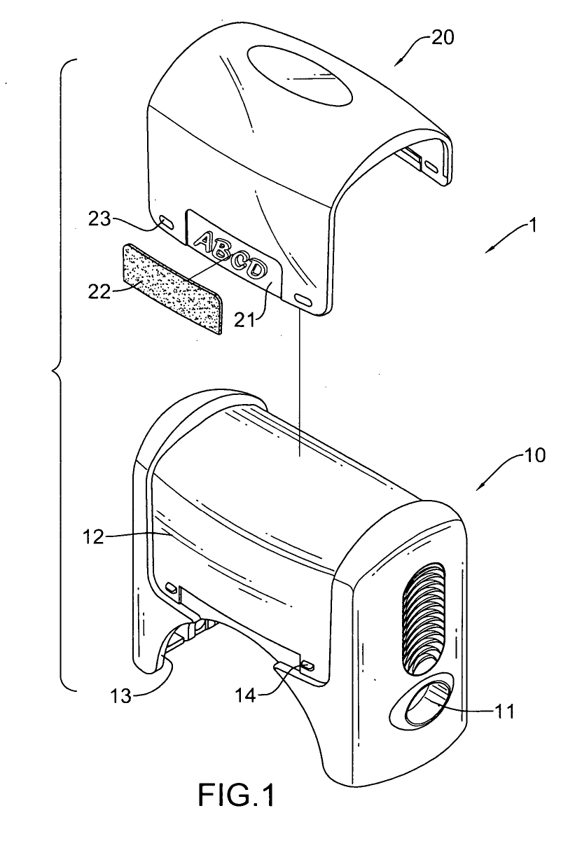

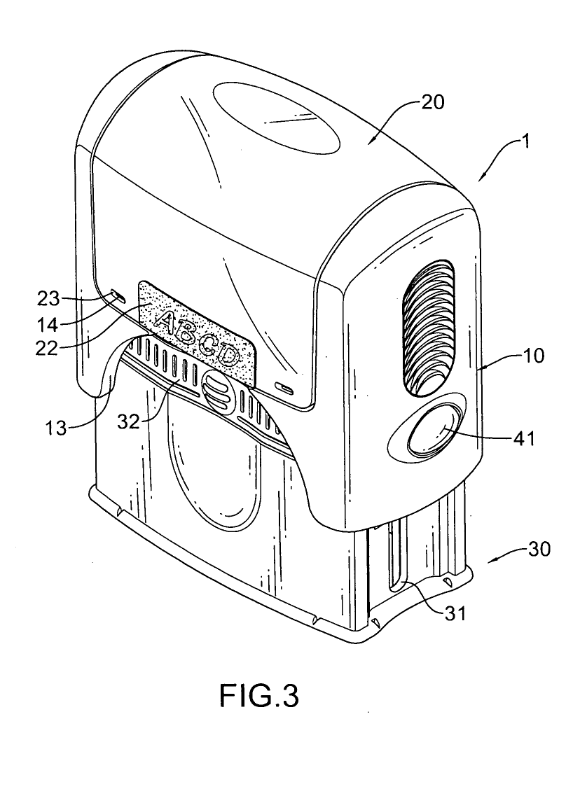

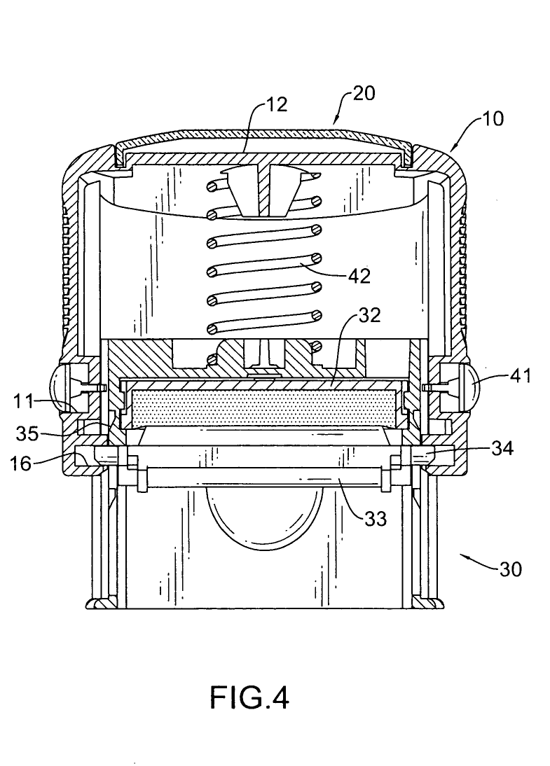

With reference to FIGS. 1-4, a housing assembly in accordance with the present invention is used in a self-inking stamp comprising a stationary casing (30), an inkpad (32), a printing pad (33), a housing assembly (1), two retaining members (41) and a spring (42).

The stationary casing (30) is hollow and has a top (not numbered), an open bottom (not numbered), two ends (not numbered), a front (not numbered), two imprinting slots (31), two detents (35) and an inkpad slot (not numbered). The imprinting slots (31) are longitudinally defined respectively in the ends of the stationary casing (30). The detents (35) are defined respectively in the ends of the stationary casing (30) above the imprinting slots (31). The inkpad slot is defined laterally in the front of the stationary casing (30) above the imprinting slots (31).

The inkpad (32) holds ink, is mounted detachably in the inkpad slot in the stationary casing (30).

The printing pad (33) is slidably and rotatably mounted in the stationary casing (30) and has two ends (not numbered) and two stubs (34). The stubs (34) are formed respectively on and protrude from the ends of the printing pad (63) and are slidably mounted respectively in the imprinting slots (31). The printing pad (33) abuts the inkpad (32) in a default situation and is selectively depressed down along the imprinting slots (31) and rotates downward to transfer an image to a document or the like to be stamped.

The housing assembly (1) is detachably mounted on the stationary casing (30) and has a slidable casing (10) and a transparent cover (20).

The slidable casing (10) is slidably mounted on the stationary casing (30) and has a top, a front, a rear, two ends, an open bottom, an identification recess (12), a curved recess (13), two optional retaining holes (11) and two optional drive holes (16).

The identification recess (12) is formed between the two ends of the slidable casing (10), can hold an object like a label, a picture or a nametag and has at least one bottom edge and multiple optional bosses (14). The at least one bottom edge is formed in the slidable casing (10) below the top of the slidable casing (10). The bosses (14) are formed near the at least one bottom edge. One embodiment of the identification recess (12) is formed in the top, front and rear of the slidable casing (10) and has two bottom edges formed respectively in the front and rear of the slidable casing (10).

The curved recess (13) is defined in the slidable casing (10) and communicates with the identification recess (12) in the slidable casing (10).

The retaining holes (11) are defined respectively in the ends of the slidable casing (10).

The drive holes (16) are defined respectively inside the ends of the slidable casing (10) below the retaining holes (11) and respectively hold the studs (34) of the printing pad (33) such that the printing pad (33) can slide along the imprinting slots (31) when the slidable casing (10) is depressed.

The transparent cover (20) corresponds to and is mounted detachably in the identification recess (12) and has a surface, a bottom edge, an optional textured area (21), a soft mat (22, 22′) and multiple optional mounting detents (23).

The textured area (21) is formed on the surface of the transparent cover (20) at the bottom edge of the transparent cover (20) and may have a raised pattern.

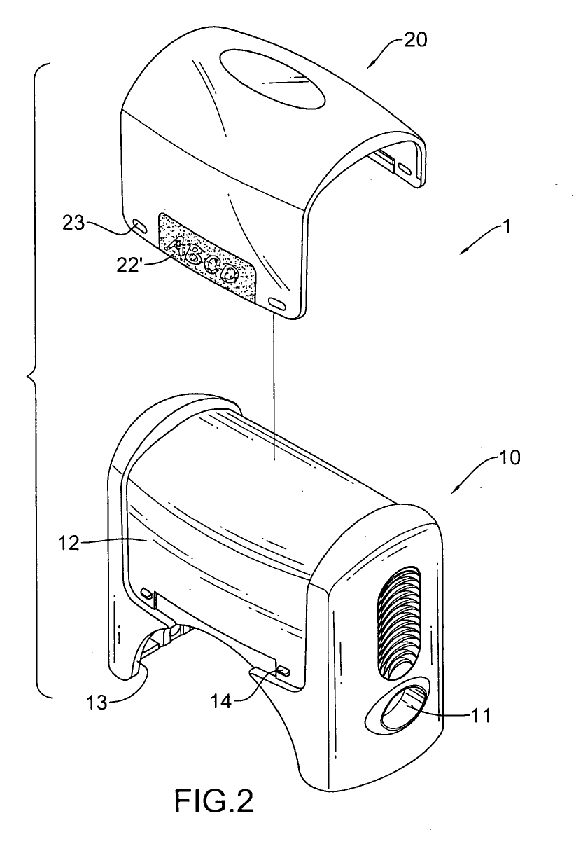

The soft mat (22, 22′) is slip-proof, is mounted on the surface and the textured area (21) of the transparent cover (20) and has a bottom edge. The bottom edge corresponds to the bottom edge of the transparent cover (20) and is exposed to the curved recess (13) so the bottom edge can be pressed to remove the transparent cover (20). With further reference to FIG. 1, in a first embodiment of the soft mat (22) in accordance with the present invention, the soft mat (22) is a separate part attached on the transparent cover (20). With further reference to FIG. 2, in a second embodiment of the soft mat (22′) in accordance with the present invention, the soft mat (22′) is formed as an integral part of the transparent cover (20). Since the soft mat (22, 22′) is slip-proof, people can press the soft mat (22, 22′) as strongly as necessary to remove the transparent cover (20) without fear of injury.

The multiple mounting detents (23) in the transparent cover (20) correspond to the bosses (14) in the identification recess (12) and are mounted detachably and respectively around the bosses (14).

The retaining members (41) are retractably mounted respectively in the retaining holes (11) in the slidable casing (10) and are selectively pressed into the detents (65) to keep the printing pad (33) from abutting the inkpad (32).

The spring (42) is mounted in the slidable casing (10) between the top of the stationary casing (30) and the top of the slidable casing (10) to push the slidable casing (10) up when the slidable casing (10) is released.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A housing assembly for a self-inking stamp comprising:
a slidable casing having
a top;
a front;
a rear;
two ends;
an open bottom;
a identification recess formed between the two ends of the slidable casing and having at least one bottom edge formed in the slidable casing below the top of the slidable casing; and
a curved recess defined in the slidable casing and communicating with the identification recess; and
a transparent cover corresponding to and detachably mounted in the identification recess and having
a surface;
a bottom edge; and
a soft mat being slip-proof, mounted on the surface of the transparent cover and having a bottom edge corresponding to the bottom edge of the transparent cover and exposed to the curved recess.

2. The housing assembly as claimed in claim 1, wherein the identification recess is formed on the top, front and rear of the slidable casing and having two bottom edges formed respectively in the front and rear of the slidable casing.

3. The housing assembly as claimed in claim 1, wherein
the transparent cover further has a textured area formed on the surface of the transparent cover at the bottom edge of the transparent cover; and
the soft mat is mounted on the textured area.

4. The housing assembly as claimed in claim 2, wherein
the transparent cover further has a textured area formed on the surface of the transparent cover at the bottom edge of the transparent cover; and
the soft mat is mounted on the textured area.

5. The housing assembly as claimed in claim 1, wherein the soft mat is formed as an integral part of the transparent cover.

6. The housing assembly as claimed in claim 1, wherein the soft mat is a separate part attached on the transparent cover.

7. The housing assembly as claimed in claim 1, wherein
the identification recess further has multiple bosses formed respectively near the at least one bottom edge of the identification recess; and
the transparent cover further has multiple mounting detents corresponding to the bosses in the identification recess and detachably mounted respectively around the bosses.

8. The housing assembly as claimed in claim 1, wherein the slidable casing further has two retaining holes defined respectively in the ends of the slidable casing.

9. The housing assembly as claimed in claim 8, wherein the slidable casing further has two drive holes defined respectively in the ends of the slidable casing below the retaining holes.
